(19) United States
(12) Patent Application Publication
(10) Pub. No.: US 2005/0159521 A1
(43) Pub. Date: Jul. 21, 2005

(54) Reversible adhesive

(76) Inventors: Donald A. Brown, Vermilion, OH (US); Harvey Lewis Kaufman, Hudson, OH (US)

Correspondence Address: Michael R. Asam;Northpoint, 901 Lakeside Ave., Cleveland, OH, 44114, US

(21) Appl. No.: 10/760,983

(22) Filed: Jan. 20, 2004

(51) Int. Cl. C08K 3/26; C08K 3/34; C08K 3/40

(52) U.S. Cl. 524/425; 524/445; 524/451; 524/494

(57) ABSTRACT

Reversible adhesive compositions, methods of making reversible adhesive compositions, and kits containing the components required to make reversible adhesive compositions are provided. A reversible adhesive composition can comprise a mixture including a free radical polymerization initiator activated by actinic light, an alkoxylated acrylate, and a pharmaceutically acceptable filler. This reversible adhesive mixture can be cured by exposure to actinic light. The cured reversible adhesive composition loses it adhesive properties when exposed to ultrasonic waves/vibrations.

### BACKGROUND

Dental apparatus, including crowns, caps, braces, veneers, inlays, fillings, and the like, are used by dentists for many purposes such as, for example, to rebuild broken or decayed teeth, strengthen teeth, or improve the cosmetic appearance of teeth. A dental apparatus is often made from a ceramic material, such as porcelain or the like, or a metal, such as gold, silver, composites, alloys, and the like. Crowns, for example, are made to fit over the visible surface of a tooth. When a crown is to be fitted, the dentist may first need to reduce the size of the tooth surface to which the crown is to be attached. When the tooth is ready the dentist then fabricates, or has fabricated, a crown that will match the exterior shape of the tooth surface being replaced. The inner surface of the crown will also be shaped to mate with the tooth surface to enable a uniform bonding between the crown and the tooth surface. The dentist then cements the crown in place with an adhesive.

Currently available dental adhesives irreversibly bond the dental apparatus to the original tooth surface. That is, the bonding is intentionally permanent, absent unintentional failure or physical intervention such as extreme force or abrasive removal. If an apparatus bonded to a tooth by such an adhesive must be removed due to misalignment upon installation, damage, discoloration, or for any other reason such as underlying tooth disease, or the like, the apparatus and adhesive must both be ground off the tooth surface. The apparatus is destroyed during this procedure and an entirely new apparatus must be fabricated and fitted.

### SUMMARY OF THE INVENTION

It has unexpectedly been discovered that the adhesive bonding of certain adhesives formed by the polymerization of particular alkoxylated arylates can be reversed by exposure to ultrasonic waves. In particular, by exposing surfaces that have been bonded together by these reversible adhesives to ultrasonic waves, the adhesive bond can be broken, thus allowing the surfaces to be separated. Particular advantages of such reversible adhesives include dental applications, where the ability to reversibly attach dental apparatus such as, for example, crowns, caps, braces, veneers, inlays, fillings, and the like, to a tooth surface would be beneficial.

Such a reversible adhesive composition can comprise a mixture including a free radical polymerization initiator activated by actinic light, an alkoxylated acrylate, and a pharmaceutically acceptable filler. This reversible adhesive mixture can be cured by exposure to actinic light. The cured reversible adhesive composition loses it adhesive properties when exposed to ultrasonic waves/vibrations.

### DETAILED DESCRIPTION OF THE INVENTION

Reversible adhesive compositions, methods of using reversible adhesive compositions, and kits for providing the components of reversible adhesive compositions are provided. The reversible adhesive compositions comprise mixtures of free radical polymerization initiators activated by actinic light, alkoxylated acrylates, and pharmaceutically acceptable fillers. The reversible adhesive compositions are cured by exposure to actinic light and the cured reversible adhesive compositions lose their adhesive properties when exposed to ultrasonic waves/vibrations. According to the methods of using reversible adhesive compositions, a reversible adhesive mixture comprising a free radical polymerization initiator activated by actinic light, an alkoxylated acrylate, and a pharmaceutically acceptable filler, is applied to a first surface, and a second surface is placed in contact with the first surface. The reversible adhesive mixture is then cured by exposure to actinic light. The methods optionally include the step of subsequently exposing the cured reversible adhesive mixture to ultrasonic waves/vibrations to cause the cured reversible adhesive to lose its adhesive properties and release the first and second surfaces. Kits are provided that comprise a free radical polymerization initiator activated by actinic light, an alkoxylated acrylate, and a pharmaceutically acceptable filler.

The free radical polymerization initiators can include any free radical initiator activated by actinic light. Examples of such actinic light sensitive free radical polymerization initiators include, but are not limited to, monoketals of an aromatic 1,2-diketone; α-diketones, such as camphoroquinone; benzophenones and substituted benzophenones; and benzoins, such as benzoin methyl ether, isopropoxybenzoin, benzoin phenyl ether, benzoin isobutyl ether and the like. Substituted benzophenones can comprise one or more constituents including, but not limited to, methyl, ethyl, and propyl groups, and combinations thereof. Examples of substituted benzophenones include, but are not limited to, 2,4,6-trimethylbenzophenone, 2,4-methylbenzophenone, 2,6-methylbenzophenone, 2-methylbenzophenone, and 4-methylbenzophenone. Further, mixtures of free radical polymerization initiators can be used. Preferably, a mixture of free radical polymerization initiators can comprise a mixture of 2,4,6-trimethylbenzophenone and 4-methylbenzophenone. More preferably, a mixture of free radical polymerization initiators can comprise about 70 to about 90 percent 2,4,6-trimethylbenzophenone and, correspondingly, about 10 to about 30 percent 4-methylbenzophenone. Even more preferably, a mixture of free radical polymerization initiators can comprise about 77 to about 80 percent 2,4,6-trimethylbenzophenone and, correspondingly, about 20 to about 23 percent 4-methylbenzophenone. Additionally, preferably a mixture of free radical polymerization initiators can comprise a mixture of 2,4,6-trimethylbenzophenone and 2-methylbenzophenone. More preferably, a mixture of free radical polymerization initiators can comprise about 70 to about 90 percent 2,4,6-trimethylbenzophenone and, correspondingly, about 10 to about 30 percent 2-methylbenzophenone. Even more preferably, a mixture of free radical polymerization initiators can comprise about 77 to about 80 percent 2,4,6-trimethylbenzophenone and, correspondingly, about 20 to about 23 percent 2-methylbenzophenone.

Suitable alkoxylated acrylates for use in the adhesive include alkoxylated acrylates, derivatives of alkoxylated acrylates, and mixtures thereof. Preferably, the alkoxy group has from 1 to about 10 carbon atoms arranged in a linear or a branched configuration. The alkoxy group of the alkoxylated acrylate can comprise a methoxy, ethoxy, propoxy, or butoxy group. Preferably, the alkoxylated acrylate is methoxylated. One example of a suitable alkoxylated acrylate is SR-9008™ (Sartomer Chemical Co., Exton, Pa.), which is an alkoxylated trifunctional acrylate ester.

The pharmaceutically acceptable fillers are preferably non-toxic, inert materials or compositions useful to thicken or impart a workable consistency to the reversible adhesive composition. The term “workable consistency” refers to a consistency/viscosity that allows a user to assert a minimal level of control over the movement, orientation, and placement of the reversible adhesive in a desired location. The selected pharmaceutically acceptable filler must be “acceptable” in the sense of being compatible with the other components of the reversible adhesive compound. Useful pharmaceutically acceptable fillers include, but are not limited to, aluminum oxide; α-quartz powders; clay; talc; silica; diatomaceous earth; titanium dioxide; calcium carbonate; starches and other carbohydrates; sugars, such as lactose, glucose and sucrose; other non-toxic fillers employed in pharmaceutical formulations; and derivatives and mixtures thereof. Pharmaceutically acceptable starches include naturally occurring starches, such as, but not limited to, corn starch, potato starch, wheat starch, and mixtures thereof. Preferably, the pharmaceutically acceptable filler is a naturally occurring starch. More preferably, the pharmaceutically acceptable filler is corn starch.

The free radical polymerization initiators, alkoxylated acrylates, and pharmaceutically acceptable fillers can be mixed together in various concentrations depending on the application desired. For example, a reversible adhesive mixture can be formed from about 0.5 to about 10 parts by weight free radical polymerization initiator, about 0.5 to about 10 parts by weight alkoxylated acrylate, and about 0.25 to about 20 parts by weight pharmaceutically acceptable filler. Preferably, a reversible adhesive composition comprises about 1 part by weight benzophenone, about 1 part by weight alkoxylated acrylate, and about 0.25 to about 1 part by weight pharmaceutically acceptable filler. More preferably, a reversible adhesive composition comprises about 1 part by weight benzophenone, about 1 part by weight alkoxylated acrylate, and about 0.25 parts by weight pharmaceutically acceptable filler.

The free radical polymerization initiators are activated by exposure to actinic light and, once activated, initiate the free radical polymerization of the alkoxylated acrylate. The term “actinic light” refers to radiant energy capable of producing chemical changes. Actinic light often has wavelengths in the visible and ultraviolet spectral regions. In the case of the free radical polymerization initiators discussed above, the chemical change produced by the actinic light is to form radicals. The radicals then initiate radical polymerization of the alkoxylated acrylate by known mechanisms. Depending on the type of free radical polymerization initiator used, the free radical polymerization initiator may co-polymerize with the alkoxylated acrylate. The process of exposing the reversible adhesive composition to actinic light and polymerizing the alkoxylated acrylate is referred to herein as curing the reversible adhesive mixture. Ambient light, especially sunlight, often provides a range of wavelengths that include actinic wavelengths. However, ambient light may not provide actinic light at a high enough intensity to cure the reversible adhesive composition in a useful period of time. Alternatively, the actinic light can be applied to the reversible adhesive composition by the use of specialized apparatus designed to emit actinic light. A suitable apparatus, for example, is the PowerPAC™ light source (American Dental Technologies, Corpus Christi, Tex.), which outputs light with wavelengths between 370 and 500 nanometers at a power level of 600 to 800 milliwatts.

The cured reversible adhesive composition loses its adhesive properties when exposed to ultrasonic waves/vibrations. The term “ultrasonic waves/vibrations” refers to waves/vibrations with frequencies above the audibility limit of human hearing. The audibility limit of human hearing is generally acknowledged to be around 20,000 Hertz. When exposed to ultrasonic waves/vibrations the molecular structure of the reversible adhesive composition breaks down, such that the adhesive properties of the reversible adhesive composition are lost or at least minimized so that the adhesive bond between surfaces can be broken with the exertion of minimal force. In this context, loss or minimization of adhesive properties means that the reversible adhesive composition no longer functions as an adhesive in its intended mode of operation. Without being bound by theory, it is believed that carbon-oxygen bonds in the polymerized alkoxylated acrylate molecules of the reversible adhesive composition are broken upon exposure to ultrasonic waves/vibrations resulting in disintegration of the adhesive and causing loss of adhesive properties. The term “disintegration” refers to breaking or decomposing into small particles, i.e., the molecules remaining on either side of a broken carbon-oxygen bond. Ultrasonic waves/vibrations can be provided by common dental scaling equipment. Examples of suitable ultrasonic scalers include, but are not limited to, the Titan® SW Plus Sonic Scaler (StarDental®, Lancaster, Pa.) and the Cavitron® SPS™ scaler (Dentsply International Inc., York, Pa.).

The free radical polymerization initiators, alkoxylated acrylates, and pharmaceutically acceptable fillers can be stored separately or stored together in various combinations, for example, as a kit. Because the free radical polymerization initiators are activated by exposure to actinic light these molecules can be protected from activation by storage in containers that are impervious to actinic light. The free radical polymerization initiators and alkoxylated acrylates can also be stored together in containers that are impervious to actinic light. When stored together the free radical polymerization initiators and alkoxylated acrylates can be stored as a mixture of the initiators and alkoxylated acrylates, or as individual components for mixing prior to use. Additionally, the free radical polymerization initiators, alkoxylated acrylates, and pharmaceutically acceptable fillers can be stored together in containers that are impervious to actinic light.

The reversible adhesive compositions discussed above are particularly useful as reversible dental adhesive compositions for attaching and removing dental apparatus such as crowns, caps, veneers, inlays, fillings, and braces to tooth surfaces. These dental apparatus can be made from ceramic materials, such as porcelain, or metals such as gold, silver, composites, and alloys. Braces, for example, are often made from metal composites and alloys. If the reversible adhesive compound is used, the dental apparatus can be removed subsequent to placement, for example, to be repositioned, or in the case of a temporary apparatus, to replace the apparatus with an apparatus for long-term use. In such cases where the reversible adhesive is to be used in a dental application, the components of the composition selected should not be injurious to the organism in which the reversible adhesive is used.

The methods comprise the steps of forming a reversible adhesive mixture, applying the reversible adhesive mixture to a first surface, placing a second surface in contact with the reversible adhesive mixture on the first surface, and curing the reversible adhesive mixture by exposure to actinic light. Optionally, the methods also include the step of subsequently exposing the cured reversible adhesive to ultrasonic waves/vibrations to cause the cured adhesive composition to lose its adhesive properties and release the first and second surfaces.

### EXAMPLE 1

A reversible adhesive mixture was formed by thoroughly manually mixing the following components in the following proportions:

| | Proportion |
|---|---|
| Component | (part by weight) |
| Sarcure TZT^{a} | 1 |
| (77-80% 2,4,6-trimethylbenzophenone; | |
| 20-23% 4-methylbenzophenone) | |
| SR9008^{a} | 1 |
| (alkoxylated trifunctional acrylate ester) | |
| Corn Starch^{b} | 1 |

^{a}Sartomer Chemical Co., Exton, PA.
^{b}Arm & Hammer Corp., Princeton, NJ.

The resultant reversible adhesive mixture had a low to medium viscosity. A two (2) millimeter layer of the reversible adhesive mixture was placed on a porcelain substrate and exposed to light having wavelengths between 370 and 500 nanometers at a power level of 600 to 800 milliwatts, using a PowerPAC™ light source (American Dental Technologies, Corpus Christi, Tex.). The reversible adhesive mixture was found to cure at the following rate:

5 seconds—top surface began to harden, i.e., was tacky;

10 seconds—top surface was cured, undersurface was not yet cured (still liquid);

15 seconds—top surface was cured, the undersurface partially cured (still slightly wet); and

20 seconds—adhesive mixture was completely cured.

### EXAMPLE 2

A reversible adhesive mixture was prepared as described in example 1. A thin layer of the reversible adhesive mixture was then applied to one side of an 8 millimeter porcelain block. A second 8 millimeter porcelain block was then placed in contact with the adhesive mixture on the first 8 millimeter porcelain block. The adhesive mixture was then cured for forty (40) seconds by exposing the common sides of the blocks for ten (10) seconds each to light having wavelengths between 370 and 500 nanometers at a power level of 600 to 800 milliwatts delivered by a PowerPAC™ light source. Once fully cured, the blocks were securely attached to one another. To reverse the adhesive bonds securely attaching the blocks to one another, the working end of a Cavitron® SPS™ ultrasonic scaler with a dental scaler attachment (Dentsply International Inc., York, Pa.) was placed at the margins on all four common sides of the attached porcelain blocks for a total of two minutes. At the end of two minutes, the reversible adhesive released and the two blocks were separated. The remaining reversible adhesive was easily removed from each porcelain block by additional scraping with the scaler and the porcelain blocks could be reused.

### EXAMPLE 3

Two (2) eight millimeter blocks were securely attached to each other using the same steps as in example 2. To reverse the adhesive bonds securely attaching the blocks to one another, a Titan® SW Plus Sonic Scaler with a dental scaler attachment (StarDental®, Lancaster, Pa.) was placed at the margins on all four common sides of the attached porcelain blocks for a total of 3.5 minutes. At the end of 3.5 minutes, the reversible adhesive released and the two blocks were separated. The remaining reversible adhesive was easily removed from each porcelain block by additional scraping with the scaler and the porcelain blocks could be reused.

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have elements that do not differ from the literal language of the claims, or if they include equivalent elements with insubstantial differences from the literal language of the claims.

1. A reversible adhesive composition, comprising a mixture of:
a free radical polymerization initiator activated by actinic light
an alkoxylated acrylate; and
a pharmaceutically acceptable filler,
wherein the reversible adhesive composition is cured by exposure to actinic light and the cured reversible adhesive composition loses its adhesive properties when exposed to ultrasonic waves/vibrations.

2. A reversible adhesive composition according to claim 1, wherein the free radical polymerization initiator comprises a benzophenone, a substituted benzophenone, or a mixture thereof.

3. A reversible adhesive composition according to claim 2, wherein the substituted benzophenone comprises one or more constituents selected from the group consisting of methyl, ethyl, and propyl groups, and combinations thereof.

4. A reversible adhesive composition according to claim 2, wherein the substituted benzophenone is selected from the group consisting of 2,4,6-trimethylbenzophenone, 2,4-methylbenzophenone, 2,6-methylbenzophenone, 2-methylbenzophenone, 4-methylbenzophenone, and mixtures thereof.

5. A reversible adhesive composition according to claim 4, wherein the mixture of benzophenones comprises about 70 to about 90 percent 2,4,6-trimethylbenzophenone and about 10 to about 30 percent of a benzophenone selected from the group consisting of 2-methylbenzophenone, 4-methylbenzophenone, and mixtures thereof.

6. A reversible adhesive composition according to claim 1, wherein an alkoxy component of the alkoxylated acrylate is selected from the group consisting of methoxy, ethoxy, propoxy, and butoxy groups.

7. A reversible adhesive composition according to claim 1, wherein the alkoxylated acrylate comprises an alkoxylated acrylate derivative comprising one or more constituents selected from the group consisting of linear or branched alkanes, alkenes, or alkynes; ethers; esters; acids; fats; sugars; and mixtures thereof.

8. A reversible adhesive composition according to claim 1, wherein the pharmaceutically acceptable filler is selected from the group consisting of aluminum oxide; α-quartz powders; clay; talc; silica; diatomaceous earth; titanium dioxide; calcium carbonate; starches; sugars; and mixtures thereof.

9. A reversible adhesive composition according to claim 8, wherein the pharmaceutically acceptable filler comprises a naturally occurring starch.

10. A reversible adhesive composition according to claim 9, wherein the pharmaceutically acceptable filler is selected from the group consisting of corn starch, potato starch, wheat starch, and mixtures thereof.

11. A reversible adhesive composition according to claim 8, wherein the pharmaceutically acceptable filler comprises corn starch.

12. A reversible adhesive composition according to claim 1, wherein the mixture comprises:
about 0.5 to about 10 parts by weight of the free radical polymerization initiator;
about 0.5 to about 10 parts by weight of the alkoxylated acrylate; and
about 0.25 to about 20 parts by weight of the pharmaceutically acceptable filler.

13. A reversible adhesive composition according to claim 1, wherein the mixture comprises:
about 1 part by weight of the free radical polymerization initiator;
about 1 part by weight of the alkoxylated acrylate; and
about 0.25 to about 1 part by weight of the pharmaceutically acceptable filler.

14. A reversible adhesive composition according to claim 1, wherein the reversible adhesive composition is a dental adhesive.

15. A reversible adhesive composition according to claim 14, wherein the reversible adhesive composition bonds a dental apparatus to a tooth surface.

16. A reversible adhesive composition according to claim 15, wherein the dental apparatus is selected from the group consisting of crowns, caps, braces, fillings, inlays, and veneers.

17. A reversible adhesive composition according to claim 15, wherein the dental apparatus comprises a material selected from the group consisting of porcelain, gold, silver, metal composites and metal alloys.

18. A reversible adhesive composition according to claim 1, wherein the components of the mixture are pre-mixed and stored in a container impervious to actinic light.

19. A reversible adhesive composition according to claim 1, wherein the free radical polymerization initiator and alkoxylated acrylic are mixed together and stored in a container impervious to actinic light.

20. A reversible adhesive composition according to claim 1, wherein the cured reversible adhesive composition disintegrates upon exposure to ultrasonic waves/vibrations by carbon-oxygen bond breakage.

21. A method for reversibly bonding two surfaces together, comprising:
a) forming a reversible adhesive mixture comprising
i) a free radical polymerization initiator activated by actinic light,
ii) an alkoxylated acrylate, and
iii) a pharmaceutically acceptable filler;
b) applying the reversible adhesive mixture to a first surface;
c) placing a second surface in contact with the reversible adhesive mixture on the first surface;
d) curing the reversible adhesive mixture by exposure to actinic light; and
e) optionally subsequently exposing the cured reversible adhesive mixture to ultrasonic waves/vibrations to cause the cured reversible adhesive composition to lose its adhesive properties and release the first and second surfaces.

22. A method according to claim 21, wherein the first surface is a tooth surface and the second surface is the surface of a dental apparatus.

23. A method according to claim 22, wherein the dental apparatus is selected from the group consisting of crowns, caps, braces, fillings, inlays, and veneers.

24. A method according to claim 23, wherein the dental apparatus comprises a material selected from the group consisting of porcelain, gold, silver, metal composites, and metal alloys.

25. A kit comprising:
a free radical polymerization initiator;
an alkoxylated acrylate; and
a pharmaceutically acceptable filler.

26. A kit according to claim 25, wherein:
the free radical polymerization initiator comprises about 0.5 to about 10 parts by weight;
the alkoxylated acrylate comprises about 0.5 to about 10 parts by weight; and
the pharmaceutically acceptable filler comprises about 0.25 to about 20 parts by weight.

27. A kit according to claim 25, wherein:
the free radical polymerization initiator comprises about 1 part by weight;
the alkoxylated acrylate comprises about 1 part by weight; and
the pharmaceutically acceptable filler comprises about 0.5 to about 1 part by weight.

28. A kit according to claim 25, wherein the free radical polymerization initiator and alkoxylated acrylic are mixed together and stored in a container impervious to actinic light.

29. A kit according to claim 25, wherein the free radical polymerization initiator, alkoxylated acrylate, and pharmaceutically acceptable filler are pre-mixed and stored in a container impervious to actinic light.

30. A reversible dental adhesive composition, comprising a mixture of:
a) about 1 part by weight of a free radical polymerization initiator activated by actinic light comprising a mixture of about 77 to about 80 percent 2,4,6-trimethylbenzophenone and about 23 to about 20 percent of a benzophenone selected from the group consisting of 2-methylbenzophenone, 4-methylbenzophenone, and mixtures thereof;
b) about 1 part by weight of an methoxylated acrylate; and
c) about 0.25 to about 1 part corn starch,
wherein the reversible dental adhesive composition is cured by exposure to actinic light and the cured reversible dental adhesive composition disintegrates when exposed to ultrasonic waves/vibrations.
